(19) United States
(12) Patent Application Publication
(10) Pub. No.: US 2002/0163812 A1
(43) Pub. Date: Nov. 7, 2002

(54) Fast assembling structure for ceiling fan lamp and ceiling fan

(76) Inventor: Ming-Chi Tseng, Taichung-Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/847,421

(22) Filed: May 3, 2001

(51) Int. Cl. F21S 8/06

(52) U.S. Cl. 362/404; 362/96; 362/226

(57) ABSTRACT

A fast assembling structure for ceiling fan lamp and ceiling fan, including a base tray and a lamp seat. The base tray has an upward extending tube. An inner wall of the tube is formed with two radially opposite slide channels axially passing through the tube and two radially opposite engaging notches. The top end of the tube is provided with a cap in which a wire-connecting disc is disposed and downward pushed by a resilient member. The lamp seat has an upward extending hollow post. A wire-connecting seat is connected with the top end of the post. A pin member is radially passed through the post near the top end thereof. Two ends of the pin member protrude out of the post. When the post is upward fitted into the tube, the pin member passes through the two slide channels. Thereafter, the post is rotated to aim the pin member at the engaging notches and the resilient member resiliently pushes the wire-connecting disc to press the post and make the pin member engaged and located in the engaging notches. At this time, the contacts of the wire-connecting seat electrically contact with the contacts of the wire-connecting disc.

### BACKGROUND OF THE INVENTION

The present invention is related to a fast assembling structure for ceiling fan lamp and ceiling fan. Simply by means of inserting a post of the lamp seat into a tube of the ceiling fan and then rotating the post, the ceiling fan and the lamp seat can be quickly connected and the wires can be electrically connected at the same time.

FIGS. 6 and 7 show a conventional ceiling fan structure. A hollow thread rod 82 is disposed in the lamp seat 81 and screwed into a thread hole 831 of the base tray 83 of the ceiling fan 8. The base tray 83 is locked on the bottom of the ceiling fan 8. Two leads 811 of the lamp seat 81 are passed through the thread rod 82 to connect with the leads 84 extending out from the ceiling fan 8.

Prior to installation of the lamp seat 81, a cock 87 is plugged in the thread hole 831 to keep the base tray 83 flush. When installing the lamp seat 81, the base tray 83 is first detached from the bottom of the ceiling fan 8 and then the cock 87 is removed to screw the thread rod 82 into the thread hole of the base tray 83. Accordingly, the base tray 83 is locked on the lamp seat 81. Then, the leads 811 of the lamp seat 81 and the leads 84 of the ceiling fan 8 are connected by wire-connecting caps 85. Then the base tray 83 is fitted with and locked on the bottom of the ceiling fan 8 by several locking bolts 86.

Such installation procedure is quite troublesome to a DIY user. Especially, the ceiling fan 8 is often first mounted on the ceiling and then the lamp seat 81 is installed. Therefore, when using the wire-connecting caps 85 to connect the leads 811 of the lamp seat 81 with the leads 84 of the ceiling fan 8, it is necessary for another person to help and hold the lamp seat 81. Otherwise, the user will have to on one hand hold the lamp seat 81 and on the other hand connect the leads. This is quite inconvenient for the user. When locking the base tray 83, it is also necessary to on one hand hold the lamp seat 81 and on the other hand lock the base tray 83.

### SUMMARY OF THE INVENTION

It is therefore a primary object of the present invention to provide a fast assembling structure for ceiling fan lamp and ceiling fan, including a base tray and a lamp seat. The base tray has an upward extending tube in which a post of the lamp seat is fitted. An inner wall of the tube is formed with two radially opposite slide channels and two radially opposite engaging notches. A pin member is radially passed through the post. Two ends of the pin member protrude out of the post. The top end of the tube is provided with a cap in which a wire-connecting disc is disposed and downward pushed by a resilient member. A wire-connecting seat is connected with the top end of the post. When the post is upward fitted into the tube, the pin member passes through the two slide channels. Thereafter, the post is rotated to aim the pin member at the engaging notches and the resilient member resiliently pushes the wire-connecting disc to press the post downward and make the pin member engaged and located in the engaging notches. At this time, the contacts of the wire-connecting seat electrically contact with the contacts of the wire-connecting disc. Accordingly, the ceiling fan and the lamp seat can be quickly connected with each other.

The present invention can be best understood through the following description and accompanying drawings wherein:

### BRIEF DESCRIPTION OF THE DRAWINGS

FIG. 1 is a perspective assembled view of the present invention;

FIG. 2 is a perspective exploded view of the present invention;

FIG. 3 is a sectional view taken along line III-III of FIG. 1;

FIG. 4A is a sectional view showing the assembling operation of the present invention in a first state;

FIG. 4B is a sectional view showing the assembling operation of the present invention in a second state;

FIG. 4C is a sectional view showing the assembling operation of the present invention in a third state;

FIG. 5 is a sectional assembled view of a second embodiment of the present invention;

FIG. 6 is a perspective exploded view of a conventional ceiling fan; and

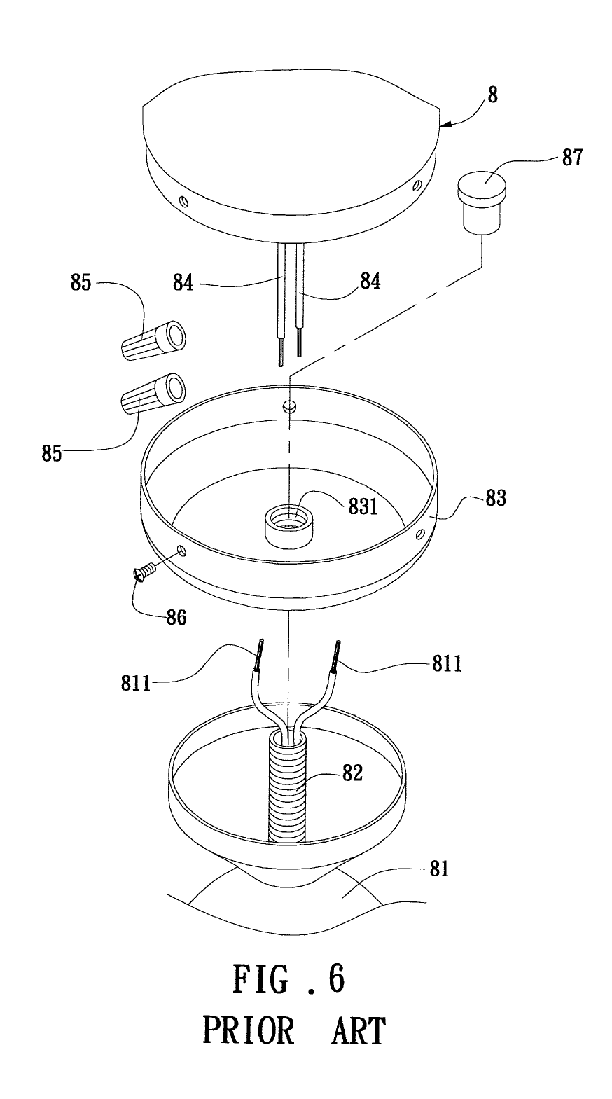

FIG. 7 is a sectional assembled view of the conventional ceiling fan.

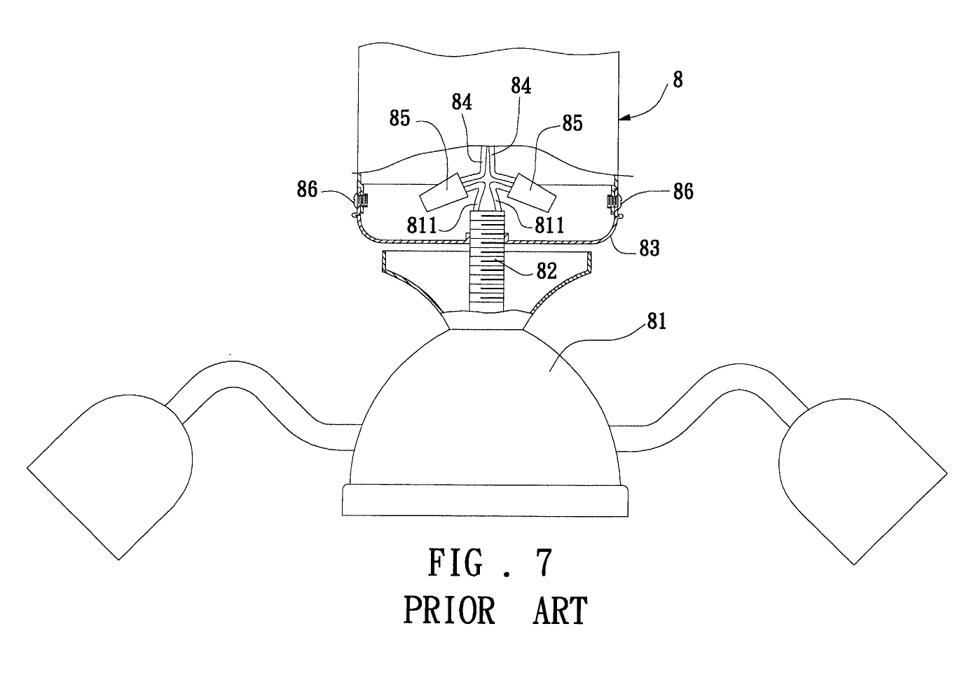

### DETAILED DESCRIPTION OF THE PREFERRED EMBODIMENTS

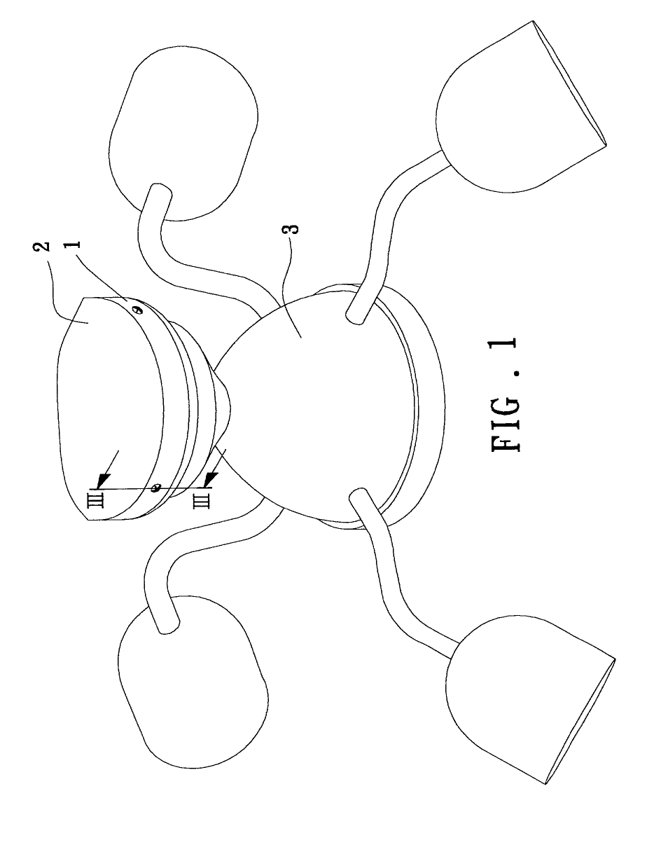

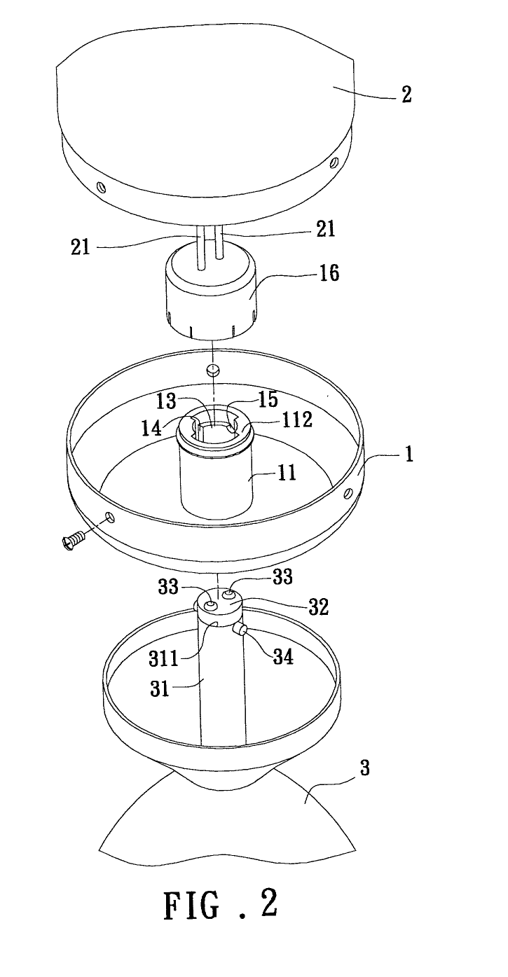

Please refer to FIGS. 1 to 5. The fast assembling structure for ceiling fan lamp and ceiling fan of the present invention includes a base tray 1 and a lamp seat 3.

The base tray 1 is connected with the bottom of the ceiling fan 2 and has an upward extending tube 11. The tube 11 has a bottom end 111 connected with the base tray I and a top end 112 opposite to the bottom end 11. An inner wall 13 of the tube 11 is formed with two radially opposite slide channels 14 axially passing through the tube 11. In addition, the inner wall 13 is formed with two radially opposite engaging notches 15. The top end of the tube 11 is provided with a cap 16 in which a wire-connecting disc 17 is disposed. A spring 18 is disposed between the wire-connecting disc 17 and the cap 16. In normal state, the spring 18 pushes the wire-connecting disc 17 downward. The wire-connecting disc 17 is connected with a circuit 21 arranged in an internal switch box of the ceiling fan 2 and has two downward extending first contacts 19.

The lamp seat 3 has an upward extending hollow post 31 for fitting into the tube 11. The post 31 has a top end 311 fitted into the tube 11 and connected with a wire-connecting seat 32. The wire-connecting seat 32 is connected with the wires inside the lamp seat 3 and has two second contacts 33 corresponding to the first contacts 19 of the wire-connecting disc 17. A pin member 34 is radially passed through the post 31 near the top end 311 thereof. Two ends of the pin member 34 protrude out of the post 31 and are slidably accommodated in the slide channels 14 of the tube 11, whereby the post 31 can be upward fitted into the tube 11. After the post 31 is rotated to aim the pin member 34 at the engaging notches 15, the spring 18 resiliently pushes the pin member 34 to engage and locate in the engaging notches 15. At this time, the second contacts 33 of the wire-connecting seat 32 electrically contact with the first contacts 19 of the wire-connecting disc 17.

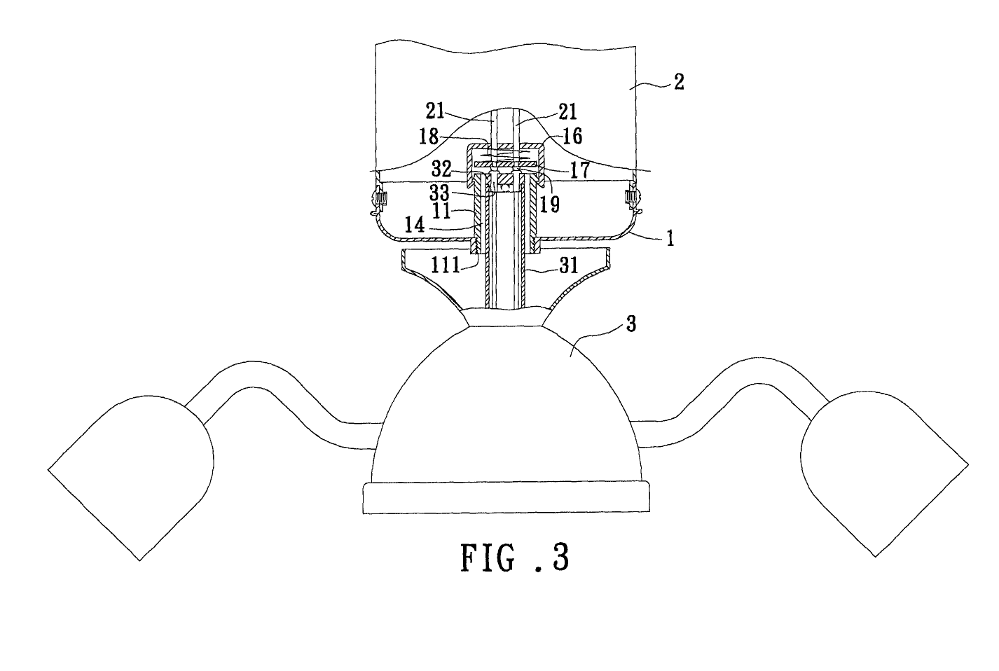

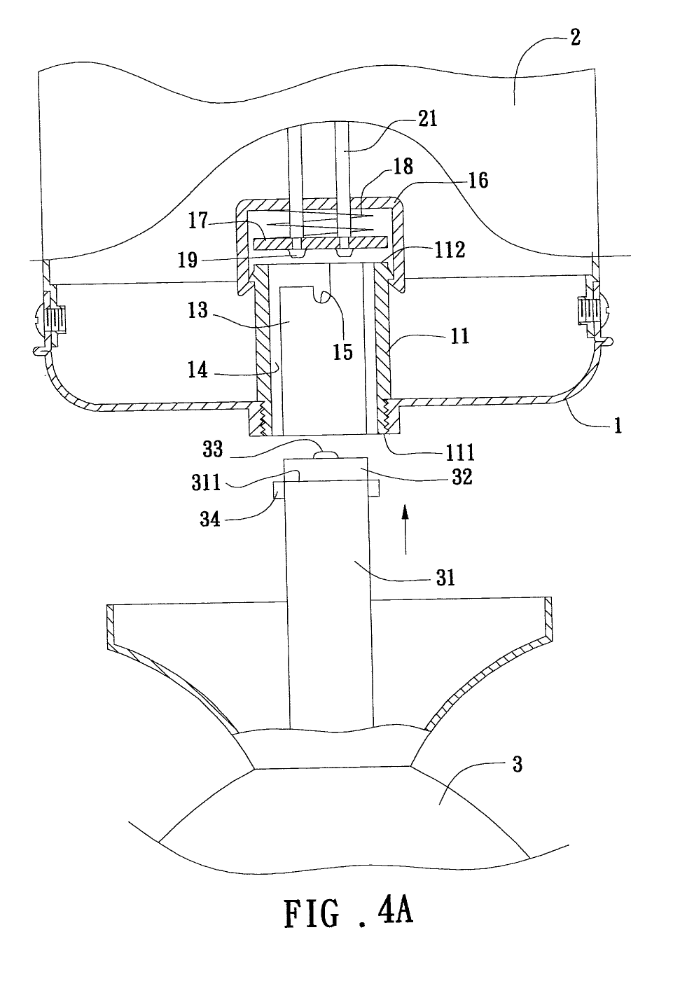

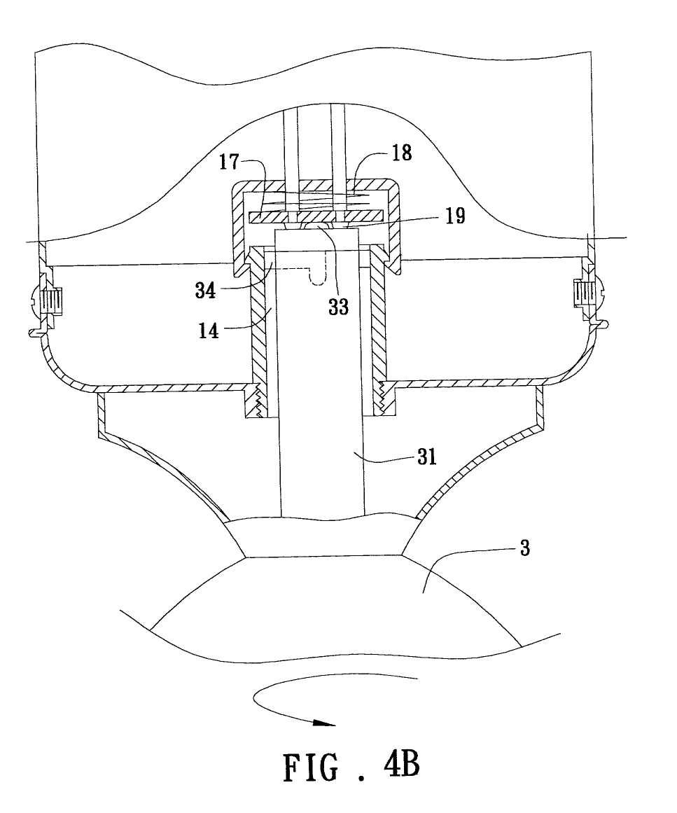

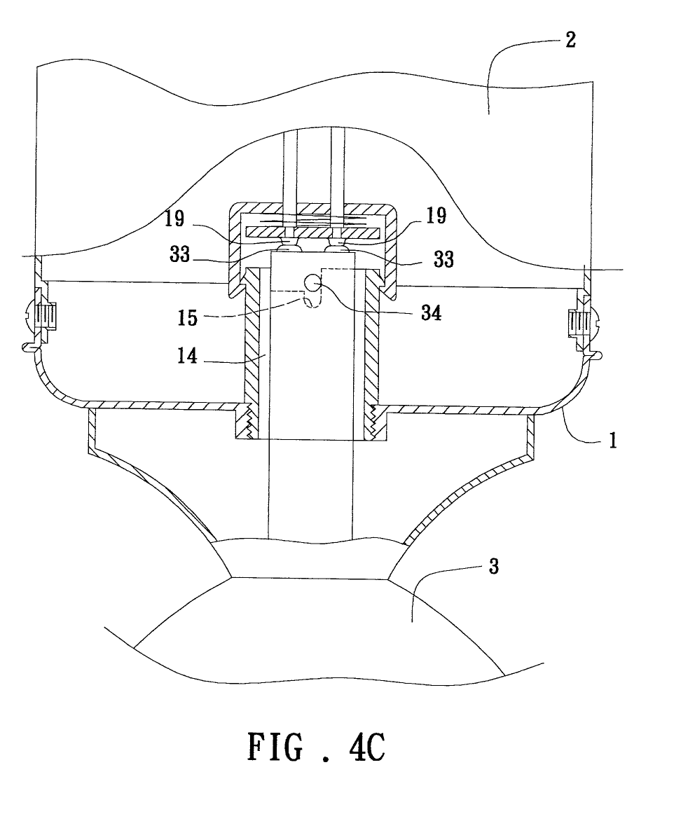

In manufacturing, the wire-connecting seat 32 is disposed at the top end of the post 31 with the second contacts 33 protruding beyond the top face of the wire-connecting seat 32. The base tray 1 is locked on the bottom of the ceiling fan 2 with the tube 11 fitted with the cap 16. A cock ( not shown ) is plugged in the bottom end 111 of the tube 11 to seal the tube 11. When the lamp seat 3 is not installed, the bottom end 111 of the tube 11 is kept flush. Referring to FIG. 4A, when a user DIY assembles the lamp seat 3, the user only needs to unplug the cock and respectively aim the post 31 and pin member 34 of the lamp seat 3 at the tube 11 and the two slide channels 14 to upward fit the post 31 into the tube 11. After the pin member 34 passes through the slide channels 14 as shown in FIG. 4B, the post 31 is rotated to aim the pin member 34 at the engaging notches 15 as shown in FIG. 4C. At this time, the second contacts 33 of the wire-connecting seat 32 electrically contact with the first contacts 19 of the wire-connecting disc 17 to close the circuit. The spring 18 resiliently pushes the wire-connecting disc 17 to press the post 31 downward so as to engage the pin member 34 into the engaging notches 15. Under such circumstance, the post 31 is connected with and located in the tube 11 as shown in FIG. 3. Accordingly, simply by means of inserting the post 31 into the tube 11 and then rotating the post 31, the ceiling fan 2 and the lamp seat 3 can be quickly connected and the wires can be electrically connected at the same time.

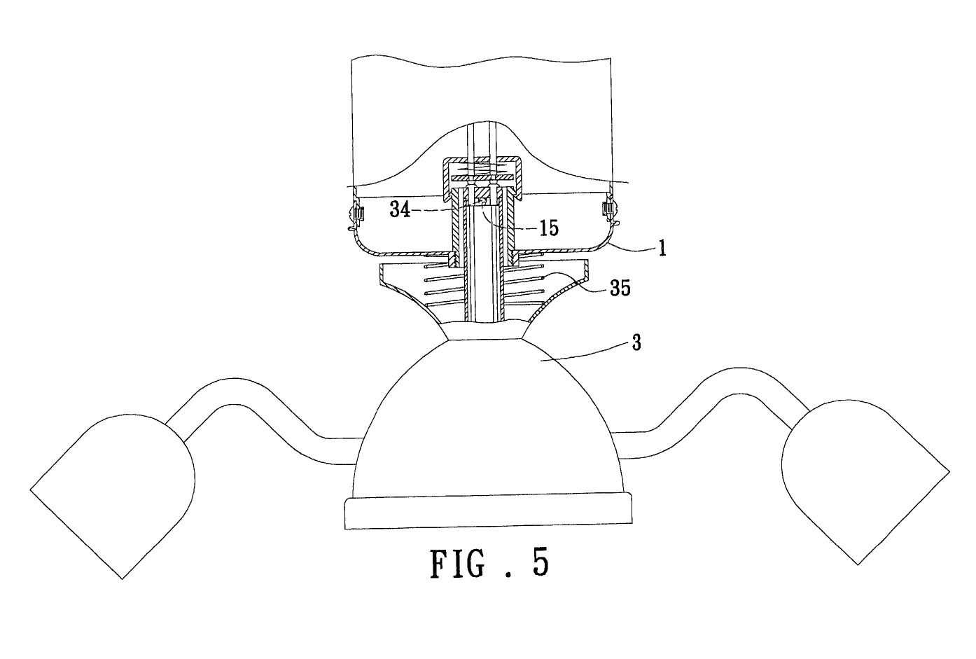

FIG. 5 shows a second embodiment of the present invention, in which a coil spring 35 is additionally disposed between the lamp seat 3 and the base tray 1 for pushing the lamp seat 3 downward to more firmly engage the pin member 34 in the engaging notches 15. This embodiment can achieve the same effect as the first embodiment.

The above embodiments are only used to illustrate the present invention, not intended to limit the scope thereof. Many modifications of the above embodiments can be made without departing from the spirit of the present invention.

What is claimed is:

1. A fast assembling structure for ceiling fan lamp and ceiling fan, comprising:
a base tray connected with the bottom of the ceiling fan and having an upward extending tube, the tube having a bottom end connected with the base tray and a top end opposite to the bottom end, an inner wall of the tube being formed with two radially opposite slide channels axially passing through the tube, the inner wall being further formed with two radially opposite engaging notches, the top end of the tube being provided with a cap in which a wire-connecting disc is disposed, a resilient member being disposed between the wire-connecting disc and the cap, in normal state, the resilient member pushing the wire-connecting disc downward, the wire-connecting disc being connected with a circuit arranged in the ceiling fan and having two downward extending first contacts; and
a lamp seat having an upward extending hollow post for fitting into the tube, the post having a top end fitted into the tube and connected with a wire-connecting seat, the wire-connecting seat being connected with the wires inside the lamp seat and having two second contacts corresponding to the first contacts of the wire-connecting disc, a pin member being radially passed through the post near the top end thereof, two ends of the pin member protruding out of the post and being slidably accommodated in the slide channels of the tube, whereby the post is upward fitted into the tube and after the post is rotated to aim the pin member at the engaging notches, the resilient member resiliently pushes the pin member to engage and locate in the engaging notches, at this time, the second contacts of the wire-connecting seat electrically contacting with the first contacts of the wire-connecting disc.

2. The fast assembling structure for ceiling fan lamp and ceiling fan as claimed in claim 1, wherein a spring is further disposed between the lamp seat and the base tray for downward pushing the lamp seat
